(19) United States
(12) Patent Application Publication
(10) Pub. No.: US 2023/0198012 A1
(43) Pub. Date: Jun. 22, 2023

(54) SOLID-STATE ELECTROLYTE MATERIALS HAVING INCREASED WATER CONTENT

(71) Applicant: Solid Power Operating, Inc., Louisville, CO (US)

(72) Inventors: Brian E. FRANCISCO, Arvada, CO (US); Samuel OBERWETTER, Lafayette, CO (US)

(21) Appl. No.: 18/085,472

(22) Filed: Dec. 20, 2022

Related U.S. Application Data
(60) Provisional application No. 63/291,835, filed on Dec. 20, 2021.

(51) Int. Cl. H01M 10/0562

(52) U.S. Cl. CPC H01M 10/0562; H01M 2300/008

(57) ABSTRACT

Described herein are solid-state electrolyte materials having high water content. The electrolyte material may include Li, T, X, A, O, and, optionally, Y, wherein T is at least one element selected from the group consisting of P, As, Si, Ge, Al, and B; X and, when present, Y is a halogen, a pseudohalogen, or a superhalogen; and A is at least one element selected from the group consisting of S, Se, and N. The electrolyte material is made generally by exposing the electrolyte precursors to a predetermined amount of water during manufacturing. Also described herein are methods of making the solid-state electrolyte material, processes for making the solid-state electrolyte material, and electrochemical cells comprising the solid-state electrolyte material.

### CROSS-REFERENCE TO RELATED APPLICATION

This application is related to and claims priority under 35 U.S.C. § 119 from U.S. Provisional Application No. 63/291,835, filed Dec. 20, 2021, entitled “Solid-State Electrolyte Materials Having Increased Water Content,” the entire contents of which are fully incorporated by reference herein for all purposes.

### FIELD OF THE DISCLOSURE

The present disclosure is directed toward solid-state electrolyte materials. Therefore, the disclosure relates to the fields of electronics, chemistry, and materials science.

### BACKGROUND

Developments in solid-state battery technology are being pursued based on known drawbacks in liquid electrolyte-based batteries and simultaneously due to explosive growth in battery powered devices. Lithium-based solid-state electrolytes, including Argyrodite-like materials such as Li₆PS₅Cl, have been widely studied due to their high ionic conductivity. However, Argyrodite-like materials and other electrolytes are also highly reactive to cathode materials. Generally, when placed near a nickel cathode, the sulfur in an electrolyte will react with the nickel forming nickel sulfide and degrading the surface of the cathode. This may lead to reduced ionic/electronic isolation of the cathode material and reduced electrochemical performance.

The presence of water during the synthesis of an electrolyte material is avoided for electrolyte precursors. It has therefore been sought to produce electrolyte materials with no water present to reduce degradation of the electrolyte precursors and thereby to maximize ionic conductivity.

What is needed is a solid-state electrolyte material that has high ionic conductivity and that has low reactivity with a cathode material. It is with these observations in mind, among others, that various aspects of the present disclosure were conceived.

### Summary of Disclosure

Described herein is a solid-state electrolyte material comprising Li, T, X, A, O, and, optionally, Y, wherein: T is at least one element selected from the group consisting of P, As, Si, Ge, Al, and B; X and, when present, Y is a halogen or a pseudohalogen; A is at least one element selected from the group consisting of S, Se, and N; and the electrolyte material has FT-IR peaks at about 975 cm⁻¹±25 cm⁻¹, 690 cm⁻¹±25 cm⁻¹, and 525 cm⁻¹±25 cm⁻¹. In some embodiments, T is P. In some embodiments, X is Cl. In some embodiments, A is S. In some embodiments, the solid-state electrolyte material is represented by the formula Li_{7-w-z}PS_{6-w-z-v}OᵥX_{w}Y_{z} In some aspects, 0<v≤1. In some embodiments, the solid-state electrolyte material may have an FT-IR spectrum as depicted in FIG. 2. In some embodiments, the amount of oxygen present in the solid-state electrolyte material is based on exposure to 40 to 1000 ppm water. In some embodiments, an electrochemical cell comprising the electrolyte material has a higher discharge capacity as compared to an electrochemical cell comprising the same electrolyte material synthesized with 0 ppm H₂O and lacking an oxygen component. In some embodiments, an electrochemical cell comprising the electrolyte material has a higher First Cycle Efficiency (FCE) as compared to an electrochemical cell comprising the same electrolyte material exposed to 0 ppm H₂O and lacking an oxygen component. In some embodiments, an electrochemical cell comprising the electrolyte material has a lower resistance rise as compared to an electrochemical cell comprising the same electrolyte material exposed to 0 ppm H₂O and lacking an oxygen component.

Further described herein is a method of preparing a solid-state electrolyte material comprising mixing reactants in accordance with the reaction below to yield a solid-state electrolyte material of the formula Li₆PS_{5-E}O_{E}Cl: XLi₂S_{(A ppm H2O)}+YP₂S_{5(B ppm H2O)}+ZLi_{X(C ppm H2O)}+WSolvent_{(D ppm H2O)}→Li₆PS_{5-E}O_{E}Cl+WSolvent; wherein E=(X*A)+(Y*B)+(Z*C)+(W*D), A, B, C, and D=ppm of H₂O per unit mass, and Z, Y, Z, and W=Unit mass; and controlling the ppm of water for each precursor and solvent to create an electrolyte material that has high ionic conductivity while having low reactivity against a high nickel content cathode.

Further described herein is an electrochemical cell comprising a positive electrode and an electrolyte material disposed between the positive electrode and a negative electrode, wherein the electrolyte material has the general structure Li_{7-w-z}PS_{6-w-z-v}OᵥX_{w}Y_{z}, and wherein X and Y are each one or more of a halogen or a pseudohalogen, 0≤w≤2, 0≤z≤2, and 0<v≤1. In some embodiments, X and Y are each selected from the group consisting of F, Cl, Br, I, BF₄, BH₄, NO₂, NO₃, and mixtures thereof. In some embodiments, the electrolyte material has a FT-IR spectrum with absorption peaks at about 975±25 cm⁻¹, 690±25 cm⁻¹, and 525±25 cm⁻¹. In some embodiments, the electrochemical cell has a higher discharge capacity as compared to a material having the general formula Li_{7-w-z}PS_{6-w-z}X_{w}Y_{z}. In some embodiments, the electrochemical cell has a higher first cycle efficiency as compared to a material having the general formula Li_{7-w-z}PS_{6-w-z}X_{w}Y_{z}. In some embodiments, the electrochemical cell has first cycle efficiency of at least about 88%. In some embodiments, the electrochemical cell has a lower charge resistance as compared to a material having the general formula Li_{7-w-z}PS_{6-w-z}X_{w}Y_{z}. In some embodiments, the electrolyte material may have an ionic conductivity of at least 1×10⁻⁴ mS/cm²

Further comprised herein is an electrochemical cell comprising a positive electrode and an electrolyte material disposed between the positive electrode and a negative electrode, wherein the electrolyte material comprises Li, S, and P. In some embodiments, the electrolyte material further comprises at least one of a halogen or a pseudohalogen.

Further described herein is a process for manufacturing an electrolyte material, the process comprising milling a mixture comprising: a plurality of electrolyte precursors, the electrolyte precursors comprising one or more lithium (Li) containing materials; and one or more phosphorus (P) containing materials; a halide or a pseudohalide; one or more solvents; and water. In some embodiments, the electrolyte precursors further comprise sulfur (S) containing materials. In some embodiments, the electrolyte precursors further comprise one or more of a halide containing material or a pseudohalide containing material. In some embodiments, the process further comprises heating the mixture after the milling. In some aspects, the heating may result in crystallization of the mixture to form the electrolyte material. In some embodiments, the mixture may include at least 100 ppm water, about 250 ppm water, about 500 ppm water, about 1000 ppm water, or about 100,000 ppm water. In some embodiments, the water is added to the solvent prior to the milling. In some embodiments, at least one of the plurality of electrolyte precursors is anhydrous. In some embodiments, the amount of water added is predetermined based on the amount of water contained in the plurality of the electrolyte precursors and the amount of water contained in the solvent. In some embodiments, the solvent is a low-polarity, aprotic solvent. In some aspects, the solvent may be selected from the group consisting of xylenes, benzene, toluene, heptane, and combinations thereof. In some additional aspects, the solvent may include ethers, esters, nitriles, ketones, or alcohols.

Further described herein is an electrochemical cell comprising a positive electrode, an electrolyte material, and a negative electrode, wherein the electrolyte material is disposed between the positive electrode and the negative electrode, and wherein the electrolyte material is made by the process comprising milling a mixture comprising: a plurality of electrolyte precursors, the electrolyte precursors comprising one or more lithium (Li) containing materials; and one or more phosphorus (P) containing materials; a halide or a pseudohalide; one or more solvents; and water.

### BRIEF DESCRIPTION OF THE FIGURES

FIG. 1 shows a flowchart of the process for preparing a solid-state electrolyte material of the present disclosure.

FIG. 2 shows a FT-IR plot of an electrolyte material of the present disclosure having water content of 0 ppm, 100 ppm, 250 ppm, 500 ppm, and 1000 ppm.

FIGS. 3A-3C show graphs depicting performance characteristics of an electrolyte material of the present disclosure having water content of 0 ppm, 100 ppm, 250 ppm, 500 ppm, and 1000 ppm.

FIG. 4 shows a plot of X-ray diffraction measurements of a solid electrolyte material produced by the process of the present disclosure.

FIG. 5 shows a plot of X-ray diffraction measurements of a solid electrolyte material produced by the process of the present disclosure.

### DETAILED DESCRIPTION

Before the present invention is disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

As used herein, “pseudohalogen” and “pseudohalide” refer to compounds that resemble halogen elements and halide ions in their chemistry. The term “pseudohalogen” and “pseudohalide” may be used interchangeably with “superhalogen” or “superhalide”, respectively.

Described herein are solid-state electrolyte materials synthesized with a predetermined amount of water having greater performance characteristics compared to similar electrolyte materials synthesized with exposure to little or no water. In some preferred embodiments, the electrolyte materials described herein exhibit greater performance in relation to discharge capacity, efficiency, and charge resistance.

The solid-state electrolyte material of the present disclosure may be a lithium Argyrodite-like material, or hydrates or solvates thereof. Lithium Argyrodite-like materials are generally known and described in the art and have the general structure Li⁺_{(12-n-y)}Tⁿ⁺A²⁻_{(6-y)}X⁻_{(y)}. In some embodiments, the solid-state electrolyte materials may include Li₃PS₄, Li₇PS₆, Li₇P₃S₁₁, Li₄PS₄X, and Li₇P₂S₈X, wherein X is a halogen or a pseudohalogen.

Generally, it is desired to synthesize electrolyte materials, including lithium Argyrodite-like materials, with little to no water present. Exposure to water during the manufacturing process introduces oxygen into the electrolyte material, which may replace atoms such as sulfur and/or phosphorus in the electrolyte material and/or form bridging oxygen bonds with sulfur (e.g., S—O—S) or phosphorus (e.g., P—O—P). The resulting oxygenated electrolyte material has greatly reduced ionic conductivity, sometimes one or more orders of magnitude lower (e.g., 1000 times lower) than the oxygen-free electrolyte material. Therefore, electrolyte materials are commonly manufactured in dry, oxygen-free environments where humidity and gas content are highly controlled.

Moreover, the presence of oxygen also reduces the reactivity with certain cathode materials such as nickel and cobalt, which are highly reactive with sulfur. In electrochemical cells containing sulfur containing electrolytes and nickel containing cathodes, the nickel reacts with the sulfur to form nickel sulfide. If the reaction continues, the nickel sulfide and other byproducts may ionically isolate the cathode material and reduce the performance of the battery cell.

However, it was unexpectedly and surprisingly found that synthesizing the electrolyte material with a predetermined amount of water may improve one or more aspects of the performance of an electrochemical cell that includes the electrolyte material. The water is present during the milling of the solid electrolyte precursors and converts into lithium-oxygen species and H₂S during the electrolyte synthesis. Thus, the synthesized electrolyte material contains an insignificant amount of water or no water. Specifically, the inventors found that although the critical current density is greatly reduced at first, further increasing the oxygen content of the electrolyte material raises the ionic conductivity closer to the ionic conductivity of an oxygen-free electrolyte material. Additionally, electrochemical cells made using the electrolyte materials of the present disclosure were surprisingly found to have a greater first cycle efficiency as compared to electrochemical cells made with oxygen-free electrolyte materials. Without wishing to be bound by any particular theory, the increased performance may be due to improved interfacial contact between the cathode material and the electrolyte material; additionally, the solid-state electrolyte material may form a more stable interface between itself and the cathode material resulting in reduced degradation of the cathode material. When the electrolyte material itself contains some amount of oxygen, particular near the surface which may form an interface with an oxygen-containing cathode material, the driving force for reaction is reduced and therefore less interfacial reaction occurs.

The electrolyte materials of the present disclosure thus strike a surprising and unexpected balance between maintaining a high ionic conductivity and reducing the activity with cathode materials such as nickel.

### I. Electrolyte Material

The solid-state electrolyte material of the present disclosure includes lithium (Li), T, X, A, and oxygen (O). In some embodiments, the solid-state electrolyte material may also include Y. In some embodiments, the solid-state electrolyte material may be represented by the formula Li_{7-w-z}TA_{6-w-z-v}OᵥX_{w}Y_{z}, wherein 0≤w≤2, 0≤z≤2, and 0<v≤2.

In some embodiments, T may be selected from the group consisting of phosphorus (P), arsenic (As), silicon (Si), germanium (Ge), aluminum (Al), boron (B), and mixtures thereof. In a non-limiting example, T is phosphorus.

In some embodiments, X and, when present, Y, may be a halogen or a pseudohalogen. In some embodiments when X and/or Y is a halogen, the halogen may be selected from the group consisting of fluorine (F), chlorine (CI), bromine (Br), Iodine (I), or combinations thereof. In some embodiments when X and/or Y is a pseudohalogen, the pseudohalogen may include borohydride (BH₄⁻), fluoroborate (BF₄⁻), azanide (NH₂⁻), nitrogen trioxide (NO₃⁻), cyanide (CN⁻), hydroxide (OH⁻), thiocyanate (SCN⁻), hydrosulfide (SH⁻), and other pseudohalogens known in the art and combinations thereof. In a non-limiting example, X is chlorine.

In some embodiments, A may be at least one element selected from the group consisting of sulfur (S), selenium (Se), and nitrogen (N). In a non-limiting example, A is sulfur.

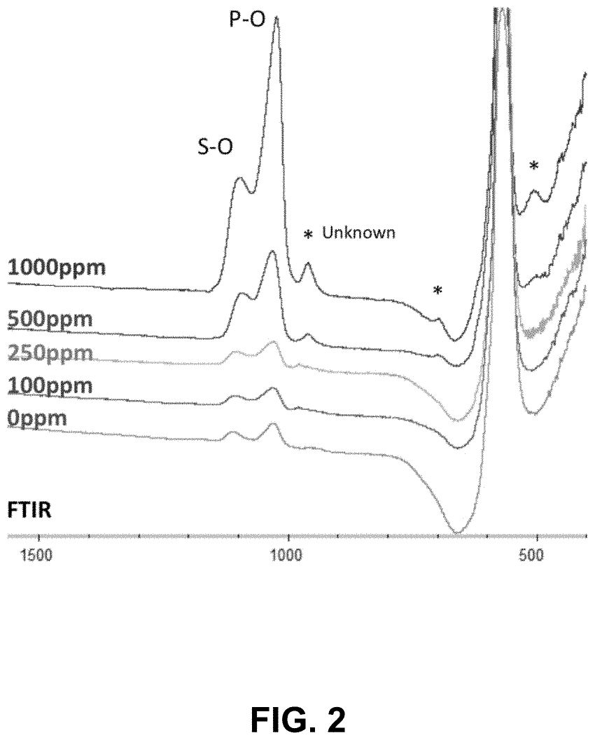

The solid-state electrolyte material of the present disclosure may have a unique FT-IR signature due to the presence of oxygen in the electrolyte material (see, e.g., FIG. 2). In some embodiments, the FT-IR spectrum of the electrolyte material of the present disclosure may have peaks at about 975 cm⁻¹±25 cm⁻¹, about 690 cm⁻¹±25 cm⁻¹, and about 525 cm⁻¹±25 cm⁻¹. In some non-limiting examples, the solid-state electrolyte material may have an FT-IR spectrum as depicted in FIG. 2.

The solid-state electrolyte material of the present disclosure may have a unique x-ray diffraction pattern (XRD). For example, a solid electrolyte material of the present disclosure comprising Li_{5.5}PS_{4.5}Cl may have peaks at 2theta=15.6°±0.5°, 18.0°±0.5°, 25.5°±0.5°, 29.9°±0.5°, and 31.5°±0.5°. As another example, a solid electrolyte material of the present disclosure comprising LiCl may have a peak at 2theta=34.8°±0.5°. As yet another example, a solid electrolyte material of the present disclosure comprising Li₂S may have a peak at 2theta=27.2°±0.5°.

As described above, the oxygen is incorporated into the electrolyte material by the presence of water during the synthesis process. In some embodiments, the amount of oxygen incorporated into the solid-state electrolyte material and the amount of water present during the synthesis process may be predetermined.

In some aspects, the amount of oxygen present in the solid-state electrolyte material may be based on exposure to 40 to 5000 ppm water during the synthesis process. Thus, the amount of oxygen present in the solid-state electrolyte material may be based on exposure to about 40 ppm water to 100 ppm water, about 100 ppm water to about 200 ppm water, about 200 ppm water to about 300 ppm water, about 300 ppm water to about 400 ppm water, about 400 ppm water to about 500 ppm water, about 500 ppm water to about 600 ppm water, about 600 ppm water to about 700 ppm water, about 700 ppm water to about 800 ppm water, about 800 ppm water to about 900 ppm water, about 900 ppm water to about 1000 ppm water, about 1000 ppm water to about 2000 ppm water, about 2000 ppm water to about 3000 ppm water, about 3000 ppm water to about 4000 ppm water, or about 4000 ppm water to about 5000 ppm water. In some aspects, the amount of oxygen present in the solid-state electrolyte material may be based on exposure to about 40 ppm water to about 200 ppm water, about 40 ppm water to about 300 ppm water, about 40 ppm water to about 400 ppm water, about 40 ppm water to about 500 ppm water, about 40 ppm water to about 600 ppm water, about 40 ppm water to about 700 ppm water, about 40 ppm water to about 800 ppm water, about 40 ppm water to about 900 ppm water, about 40 ppm water to about 1000 ppm water, about 40 ppm water to about 2000 ppm water, about 40 ppm water to about 3000 ppm water, about 40 ppm water to about 4000 ppm water, about 3000 ppm water to about 5000 ppm water, about 2000 ppm water to about 5000 ppm water, about 1000 ppm water to about 5000 ppm water, about 900 ppm water to about 5000 ppm water, about 800 ppm water to about 5000 ppm water, about 700 ppm water to about 5000 ppm water, about 600 ppm water to about 5000 ppm water, about 500 ppm water to about 5000 ppm water, about 400 ppm water to about 5000 ppm water, about 300 ppm water to about 5000 ppm water, about 200 ppm water to about 5000 ppm water, or about 100 ppm water to about 5000 ppm water. In still further aspects, the amount of oxygen present in the solid-state electrolyte material may be based on exposure to about 40 ppm water, 100 ppm water, 200 ppm water, 300 ppm water, 400 ppm water, 500 ppm water, 600 ppm water, 700 ppm water, 800 ppm water, 900 ppm water, 1000 ppm water, 2000 ppm water, 3000 ppm water, 4000 ppm water, or about 5000 ppm water. In some embodiments, the amount of oxygen present in the solid-state electrolyte material may be based on exposure to greater than about 5000 ppm water. In some non-limiting examples, the amount of oxygen present in the solid-state electrolyte material may be based on exposure to about 100 ppm water, about 250 ppm water, about 500 ppm water, or about 1000 ppm water. In still further embodiments, the amount of oxygen present in the solid-state electrolyte material may be based on exposure to at least about 40 ppm water, at least about 100 ppm water, at least about 200 ppm water, at least about 300 ppm water, at least about 400 ppm water, at least about 500 ppm water, at least about 600 ppm water, at least about 700 ppm water, at least about 800 ppm water, at least about 900 ppm water, at least about 1000 ppm water, at least about 2000 ppm water, at least about 3000 ppm water, at least about 4000 ppm water, or at least about 5000 ppm water.

In some additional aspects, the amount of oxygen present in the solid-state electrolyte material may be based on exposure to about 40 to about 100,000 ppm water during the synthesis process. The amount of oxygen present in the solid-state electrolyte material may be based on exposure of about 40 ppm to about 100 ppm, about 100 ppm to about 500 ppm, about 500 ppm to about 1,000 ppm, about 1,000 ppm to about 5,000 ppm, about 5,000 ppm to about 10,000 ppm, about 10,000 ppm to about 25,000 ppm, about 25,000 ppm to about 50,000 ppm, about 50,000 ppm to about 75,000 ppm, or about 75,000 ppm to about 100,000 ppm. In additional aspects, the amount of oxygen present in the solid-state electrolyte material may be based on exposure of about 100 ppm to about 500 ppm, about 100 ppm to about 1,000 ppm, about 100 ppm to about 5,000 ppm, about 100 ppm to about 10,000 ppm, about 100 ppm to about 25,000 ppm, about 100 ppm to about 50,000 ppm, about 100 ppm to about 75,000 ppm, about 100 ppm to about 100,000 ppm, about 500 ppm to about 100,000 ppm, about 1,000 ppm to about 100,000 ppm, about 5,000 ppm to about 100,000 ppm, about 10,000 ppm to about 100,000 ppm, about 25,000 ppm to about 100,000 ppm, about 50,000 ppm to about 100,000 ppm, or about 75,000 ppm to about 100,000 ppm. In some examples, the amount of oxygen present in the solid-state electrolyte material may be based on exposure of about 40 ppm, about 100 ppm, about 500 ppm, about 1,000 ppm, about 5,000 ppm, about 10,000 ppm, about 25,000 ppm, about 50,000 ppm, about 75,000 ppm, or about 100,000 ppm.

In some embodiments, the solid-state electrolyte material of the present disclosure may have improved performance as compared to a solid-state electrolyte material with the general formula Li_{(7-w-z)}PS_{(6-w-z)}X_{w}Y_{z}, wherein X and Y are each a halogen or a pseudohalogen, wherein 0≤w≤2, 0≤z≤2, and w+z=2. In some additional embodiments, the solid-state electrolyte material of the present disclosure may have improved performance as compared to the same electrolyte material synthesized with 0 ppm H₂O and/or lacking an oxygen component. The improved performance metrics may include discharge capacity, first cycle efficiency, and lower charge resistance.

In some embodiments, the solid-state electrolyte materials of the present disclosure generally have a lower ionic conductivity as compared to a solid-state electrolyte material having the general formula Li_{(7-w-z)}PS_{(6-w-z)}X_{w}Y_{z}, wherein X and Y are each a halogen or a pseudohalogen, wherein 0≤w≤2, 0≤z≤2, and w+z=2. In some additional embodiments, the solid-state electrolyte material of the present disclosure may have a lower ionic conductivity as compared to the same electrolyte material synthesized with 0 ppm H₂O and lacking an oxygen component. However, the improvements in the other metrics described above outweighs this loss in ionic conductivity for many applications. In some embodiments, the ionic conductivity of the solid-state electrolyte of the present disclosure may be at least about 1×10⁻⁶ mS/cm². In some aspects, the ionic conductivity of the solid-state electrolyte of the present disclosure may be at least about 1×10⁻⁵ mS/cm², at least about 1×10⁻⁴ mS/cm², or at least about 1×10⁻³ mS/cm².

### II. Method of Making the Solid-State Electrolyte Material

The solid-state electrolyte material described in Section I may be synthesized by mixing reactants in accordance with the reaction below.

αLi₂A_{(a ppm water)}+βT₂A_{5(b ppm water)}+γLiX_{(c ppm water)}+δLiY_{(d ppm water)}+εSolvent_{(e ppm water)}→Li_{7-w-z}TA_{6-w-z-v}OᵥX_{w}Y_{z}+εSolvent

wherein, v=(α*a)+(β*b)+(γ*c)+(δ*d)+(ε*e),

a, b, c, d, and e=ppm of water per mol, and

α, β, γ, δ, and ε=mol.

The species of reactants A, T, X, and Y may be those described in Section I above. In some preferred embodiments, the reactant species may be anhydrous, i.e., the reactant species may each or collectively have a water content of 0 ppm. In other embodiments, the reactant species may each or collectively have a water content of greater than 0 ppm. The water content of the reactants may be considered to determine how much water to add during the reaction to achieve a desired oxygen content of the electrolyte material. As used herein, the term “reactant” and “reactant species” may be used interchangeably with the terms “precursor” or “electrolyte precursor.”

The solvent may be any aprotic solvent with low polarity. In some embodiments, the solvent may include one or more of aromatic hydrocarbons (e.g., benzene, toluene, xylenes), alkanes (e.g., pentane, hexane, heptane, octane, nonane, decane), cycloalkanes (e.g., cyclopentane, cyclohexane, cycloheptane, cyclooctane, cyclononane, cyclodecane), chloroform, diethyl ether, and combinations thereof. In some aspects, the solvent may have a low propensity to generate hydrogen sulfide gas when in contact with the electrolyte material precursors or with the final electrolyte material. Preferably, the solvent may remain in a liquid state during at least part of the milling process or during the entire milling process (see Section III below). The solvent may have a water content of 0 ppm or greater. In some embodiments, water may be added to the solvent to achieve a desired oxygen content of the electrolyte material. In some additional embodiments, the reaction may include the use of one or more co-solvents, selected from the solvents described above.

The solvent may include ethers. Examples of ethers suitable for use in the methods described herein include tetrahydrofuran, diethyl ether, dibutyl ether, dipentyl ether, dimethoxyethane (DME), dioxane, anisole, and combinations thereof, as well as other ethers known in the art.

The solvent may include esters. Examples of esters suitable for use in the methods described herein include ethyl acetate, ethyl butyrate, isobutyl acetate, butyl acetate, butyl butyrate and butyl propanoate, and combinations thereof, as well as other esters known in the art.

The solvent may include nitriles. Examples of nitriles suitable for use in the methods described herein include acetonitrile, propionitrile, butyronitrile, isobutyronitrile, and combinations thereof, as well as other nitriles known in the art.

The solvent may include alcohols. Examples of alcohols suitable for use in the methods described herein include methanol, ethanol, propanol, butanol, isopropanol, isobutanol, and combinations thereof, as well as other alcohols known in the art.

The solvent may include ketones. Examples of ketones suitable for use in the methods described herein include acetone, cyclohexanone, diacetone, methyl ethyl ketone, methyl isobutyl ketone, and combinations thereof, as well as other ketones known in the art.

The ppm of water for each reactant and the solvent may be controlled to create an electrolyte material that has high ionic conductivity and low reactivity against a cathode, such as a cathode having a high nickel content.

In some aspects, the total water content of the mixture (i.e., the reactants and the solvent) may be from 40 to 5000 ppm water. Thus, total water content of the mixture may be from about 40 ppm water to 100 ppm water, about 100 ppm water to about 200 ppm water, about 200 ppm water to about 300 ppm water, about 300 ppm water to about 400 ppm water, about 400 ppm water to about 500 ppm water, about 500 ppm water to about 600 ppm water, about 600 ppm water to about 700 ppm water, about 700 ppm water to about 800 ppm water, about 800 ppm water to about 900 ppm water, about 900 ppm water to about 1000 ppm water, about 1000 ppm water to about 2000 ppm water, about 2000 ppm water to about 3000 ppm water, about 3000 ppm water to about 4000 ppm water, or about 4000 ppm water to about 5000 ppm water. In some aspects, the total water content of the mixture may be from about 40 ppm water to about 200 ppm water, about 40 ppm water to about 300 ppm water, about 40 ppm water to about 400 ppm water, about 40 ppm water to about 500 ppm water, about 40 ppm water to about 600 ppm water, about 40 ppm water to about 700 ppm water, about 40 ppm water to about 800 ppm water, about 40 ppm water to about 900 ppm water, about 40 ppm water to about 1000 ppm water, about 40 ppm water to about 2000 ppm water, about 40 ppm water to about 3000 ppm water, about 40 ppm water to about 4000 ppm water, about 3000 ppm water to about 5000 ppm water, about 2000 ppm water to about 5000 ppm water, about 1000 ppm water to about 5000 ppm water, about 900 ppm water to about 5000 ppm water, about 800 ppm water to about 5000 ppm water, about 700 ppm water to about 5000 ppm water, about 600 ppm water to about 5000 ppm water, about 500 ppm water to about 5000 ppm water, about 400 ppm water to about 5000 ppm water, about 300 ppm water to about 5000 ppm water, about 200 ppm water to about 5000 ppm water, or about 100 ppm water to about 5000 ppm water. In still further aspects, the total water content of the mixture may be about 40 ppm water, 100 ppm water, 200 ppm water, 300 ppm water, 400 ppm water, 500 ppm water, 600 ppm water, 700 ppm water, 800 ppm water, 900 ppm water, 1000 ppm water, 2000 ppm water, 3000 ppm water, 4000 ppm water, or about 5000 ppm water. In some embodiments, the total water content of the mixture may be greater than about 5000 ppm water. In some non-limiting examples, the total water content of the mixture may be about 100 ppm water, about 250 ppm water, about 500 ppm water, or about 1000 ppm water. In still further embodiments, the total water content of the mixture may be at least about 40 ppm water, at least about 100 ppm water, at least about 200 ppm water, at least about 300 ppm water, at least about 400 ppm water, at least about 500 ppm water, at least about 600 ppm water, at least about 700 ppm water, at least about 800 ppm water, at least about 900 ppm water, at least about 1000 ppm water, at least about 2000 ppm water, at least about 3000 ppm water, at least about 4000 ppm water, or at least about 5000 ppm water.

In some additional aspects, the total water content of the mixture may be from about 40 to about 100,000 ppm water. The total water content of the mixture may be from about 40 ppm to about 100 ppm, about 100 ppm to about 500 ppm, about 500 ppm to about 1,000 ppm, about 1,000 ppm to about 5,000 ppm, about 5,000 ppm to about 10,000 ppm, about 10,000 ppm to about 25,000 ppm, about 25,000 ppm to about 50,000 ppm, about 50,000 ppm to about 75,000 ppm, or about 75,000 ppm to about 100,000 ppm. In additional aspects, the total water content of the mixture may be from about 100 ppm to about 500 ppm, about 100 ppm to about 1,000 ppm, about 100 ppm to about 5,000 ppm, about 100 ppm to about 10,000 ppm, about 100 ppm to about 25,000 ppm, about 100 ppm to about 50,000 ppm, about 100 ppm to about 75,000 ppm, about 100 ppm to about 100,000 ppm, about 500 ppm to about 100,000 ppm, about 1,000 ppm to about 100,000 ppm, about 5,000 ppm to about 100,000 ppm, about 10,000 ppm to about 100,000 ppm, about 25,000 ppm to about 100,000 ppm, about 50,000 ppm to about 100,000 ppm, or about 75,000 ppm to about 100,000 ppm. In some examples, the total water content of the mixture may be about 40 ppm, about 100 ppm, about 500 ppm, about 1,000 ppm, about 5,000 ppm, about 10,000 ppm, about 25,000 ppm, about 50,000 ppm, about 75,000 ppm, or about 100,000 ppm.

The reaction generally takes place in an inert atmosphere comprising or consisting of argon (Ar) or nitrogen (N₂) gas. In some embodiments, the inert atmosphere may have a water content of 0 ppm. This helps to control the amount of water added to the solid-state electrolyte material and to prevent excess water from reacting with the solid-state electrolyte material. In other embodiments, the atmosphere may have a water content of greater than 0 ppm.

The reaction may take place over about 6 seconds to about 200 hours. In some embodiments, the reaction may take place over 6 seconds, 15 seconds, 30 seconds, 1 minute, 5 minutes, 15 minutes, 30 minutes, 1 hour, 2 hours, 4 hours, 12 hours, 24 hours, 48 hours, 100 hours, 200 hours, or over 200 hours. Those having ordinary skill in the art will appreciate that the duration of the reaction may be influenced by several variables, including energy input, temperature, particle size of the reactants, solvent species, etc.

The final electrolyte material may include impurities. In some embodiments, the impurities may include reactants that did not fully incorporate into the solid-state electrolyte material. In some examples, the impurities may include LiX (wherein X is a halogen or a pseudohalogen), Li₂S, or other reactants.

Ordinarily, an electrolyte material synthesized in dry conditions will react with water and/or air in the environment, causing the phosphorus and sulfur species in the electrolyte to bond with the oxygen and releasing sulfur in the form of H₂S. This reaction degrades the electrolyte material. It was surprisingly found that by incorporating oxygen in the form of water into the synthesis of the solid-state electrolyte material and replacing some of the sulfur atoms with oxygen, the reaction between the electrolyte and the water/air could be slowed.

Moreover, the presence of oxygen in the solid-state electrolyte material slows the reaction between the electrolyte and high nickel-content cathodes. When the electrolyte contacts the surface of a cathode with a high concentration of nickel, the sulfur in the electrolyte reacts with the nickel to form nickel sulfide (NiS). This reaction degrades both the electrolyte and the cathode. It was surprisingly found that by replacing the sulfur atoms in the solid-state electrolyte material with oxygen, the reactivity of the electrolyte material and the cathode are reduced, thus slowing the degradation of both the electrolyte and the cathode.

In some embodiments, the rate of degradation of the solid-state electrolyte and/or the cathode may be determined by measuring the capacity of the electrochemical cell as it is charged and discharged over time. In some additional embodiments, the rate of degradation of the solid-state electrolyte and/or the cathode may be determined by measuring first cycle efficiency of the electrochemical cell.

### III. Process for Making the Electrolyte Material

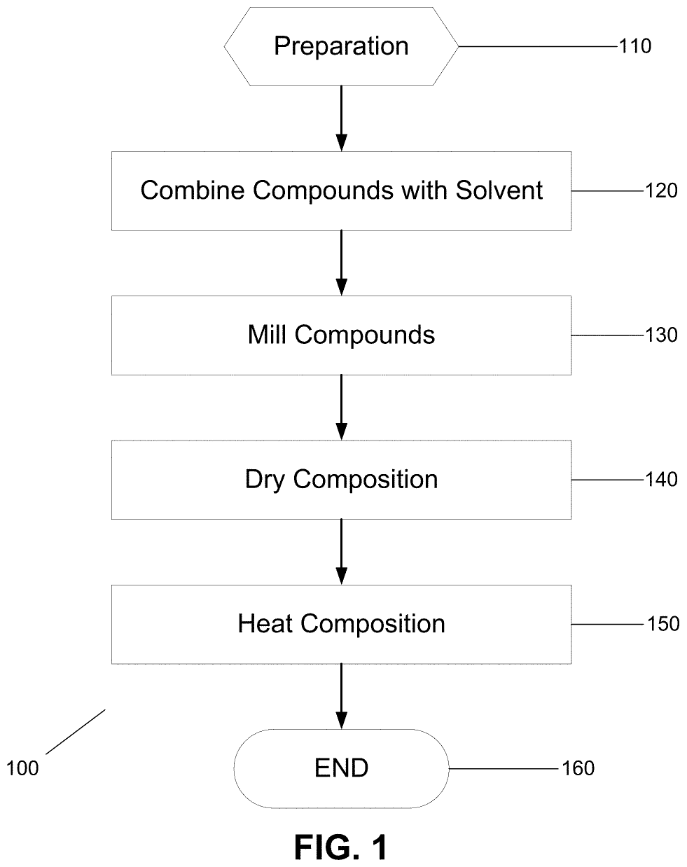

FIG. 1 shows a flowchart of a process for producing a solid electrolyte composition of the present disclosure. The process 100 begins with a preparation step 110 wherein any preparation action such as precursor synthesis, purification, and equipment preparation may take place. After any initial preparation, the process 100 advances to step 120 wherein materials comprising lithium, materials comprising phosphorus, materials comprising sulfur, materials comprising selenium, materials comprising nitrogen, and mixtures thereof, such as those described in Sections I and II, may be combined with one or more solvents and/or other liquids. Some materials may fall into multiple categories; for example, lithium sulfide (Li₂S) may be considered a material comprising lithium and a material comprising sulfur. In some embodiments, each of the materials may be provided as a powder, granules, pellets, bricks, flakes, or other dry or solid forms known in the art. In some of the examples, each of the materials may be provided in a powder form. When materials are provided in a powder form, they may be provided as a crystalline powder, an amorphous powder, or both. The one or more solvents may be one or more low polarity, aprotic solvents as described in Section II.

In some embodiments, the materials comprising lithium may include lithium metal, lithium sulfide (Li₂S), lithium chloride (LiCl), lithium nitride (Li₃N), lithium borohydride (LiBH₄), lithium fluoroborate (LiBF₄), lithium amide (LiNH₂), lithium nitrate (LiNO₃), and mixtures thereof.

In some embodiments, the materials comprising sulfur may include elemental sulfur, phosphorous sulfides including phosphorous pentasulfide (P₂S₅) and phosphorus sulfides having the general chemical formula P₄S, where 3≤x≤10, lithium sulfide (Li₂S), alkali metal sulfides, alkaline metal sulfides, boron sulfide (B₂S₃), aluminum sulfide (Al₂S₃), antimony trisulfide (Sb₂S₃), antimony pentasulfide (Sb₂S₅), germanium sulfide (Ge₂S₃), silicon trisulfide (Si₂S₃), copper monosiulfide (CuS), copper disulfide (CuS₂), zinc sulfide (ZnS), iron sulfide (FeS₂), tin sulfide (SnS) and mixtures thereof. In some examples, the phosphorus sulfides having the general chemical formula P₄Sₓ where 3≤x≤10 include P₄S₃, P₄S₄, P₄S₅, P₄S₆, P₄S₇, P₄S₈, P₄S₉, P₄S₁₀, or combinations thereof. In further examples, the alkali metal sulfides include sodium sulfide (Na₂S), potassium sulfide (K₂S), rubidium sulfide (Rb₂S), and cesium sulfide (Cs₂S). In still further examples, the alkaline metal sulfides include beryllium sulfide (BeS), calcium sulfide (CaS), magnesium sulfide (MgS), strontium sulfide (SrS), and barium sulfide (BaS). In some embodiments, the materials comprising phosphorus may include elemental phosphorus, phosphorous sulfides including phosphorus pentasulfide (P₂S₅), phosphorus oxides including phosphorus pentoxide (P₂S₅) and phosphorus sulfides having the general chemical formula P₄S, where 3≤x≤10, phosphorus chlorides including phosphorus trichloride (PCl₃) and phosphorus pentachloride (PCl₅), phosphorus oxychloride (POCl₃), and mixtures thereof.

In some embodiments, the materials comprising selenium may include selenium sulfide (Se₂S), selenium disulfide (SeS₂), and mixtures thereof.

The ratios and amounts of the reactant compounds may not be specifically limited as long as the water content of the reactant compounds and the one or more solvents is predetermined to achieve the desired oxygen content of the solid-state electrolyte material. The amount of solvent added may be predetermined based on the water content of each of the reactant compounds and based on the water content of the solvent. The amount of solvent added may thus be adjusted to achieve a desired oxygen content in the final electrolyte material. Moreover, water may be added to the solvent or to the mixture of the reactant compounds and the solvent to achieve the desired oxygen content of the electrolyte material. Additional materials, including co-solvents and polymers, may be added during this step 120.

Next, in step 130 the composition may be mixed and/or milled for a predetermined period of time and at a predetermined temperature in order to create a solid electrolyte as described in Sections I and II. Mixing may be accomplished by methods known to those having skill in the art. In some non-limiting examples, mixing is accomplished using a planetary ball-milling machine or an attritor mill. Mixing time is not specifically limited as long as it allows for appropriate homogenization and reaction of precursors to generate the solid-state electrolyte material. The mixing temperature is not specifically limited as long as it allows for appropriate mixing and is not so high that a precursor enters the gaseous state.

In some embodiments, appropriate mixing may be accomplished over about 6 seconds to over about 200 hours at temperatures from about −20° C. to about 200° C. Those having skill in the art will appreciate that the amount of time required for adequate mixing may be influenced by various factors, including energy input, temperature, particle size of the precursors, solvent species, etc. In some aspects, appropriate mixing may be accomplished over about 6 seconds, 30 seconds, 1 minute, 5 minutes, 10 minutes, 30 minutes, 1 hour, 2 hours, 3 hours, 6 hours, 12 hours, 24 hours, 36 hours, 48 hours, 100 hours, 200 hours, or greater than 200 hours. In some examples, appropriate mixing may be accomplished after about 10 minutes to about 48 hours. In some additional aspects, appropriate mixing may be accomplished at temperatures of about −20° C. to about 0° C., about 0° C. to about 25° C., about 25° C. to about 50° C., about 50° C. to about 75° C., about 75° C. to about 100° C., about 100° C. to about 125° C., about 125° C. to about 150° C., about 150° C. to about 175° C., or about 175° C. to about 200° C.

By introducing water prior to step 130 and milling/mixing the composition with greater than 0 ppm water, the resulting electrolyte material contains oxygen homogeneously distributed throughout the composition, as opposed to a composition that contains only a surface layer of oxygen.

Next, in step 140, the composition may be dried in an inert atmosphere such as argon or nitrogen or under vacuum for a predetermined period of time and at a predetermined temperature. The drying may occur in either a static or preferably an agitated drying operation. Following drying, heat treatment may be performed during an optional step 150. The temperature of the heat treatment is not particularly limited, as long as the temperature is equal to or above the temperature required to generate the crystalline phase of the solid electrolyte material of the present disclosure, or as required to enhance the ionic conductivity or the lithium metal compatibility. The material resulting from the heat treatment step 150 may be single phase, and may also contain other crystalline phases, glass phases, and minor fractions of precursor phases.

Generally, the heat treatment time is not limited as long as the heat treatment time allows production of the desired composition and phase. The time may be in the range of, for example, about 1 minute to about 24 hours. In some aspects, the heat treatment may be conducted over about 1 minute, 10 minutes, 30 minutes, 1 hour, 2 hours, 4 hours, 6 hours, about 12 hours, about 18 hours, or about 24 hours. Further, the heat treatment may be conducted in an inert gas atmosphere (e.g., argon or nitrogen), a reducing atmosphere (e.g., hydrogen), or under vacuum. The heat treatment step 150 may be skipped entirely if the desired composition and phase is achieved during the earlier mixing and drying steps.

### IV. Electrochemical Cell

The solid-state electrolyte material described herein may be used in a solid-state electrochemical cell. The solid-state electrolyte material may be disposed between a positive electrode and a negative electrode in a solid-state electrolyte material layer. The solid-state electrolyte material layer may include a solid-state electrolyte material of the present disclosure at a concentration of about 10% to about 100% by volume. In some embodiments, the concentration of the solid-state electrolyte material of the present disclosure in the solid-state electrolyte material layer may be about 10% to about 20%, about 20% to about 30%, about 30% to about 40%, about 40% to about 50%, about 50% to about 60%, about 60% to about 70%, about 70% to about 80%, about 80% to about 90%, or about 90% to about 100% by volume. In some additional embodiments, the concentration of the solid-state electrolyte material of the present disclosure in the solid-state electrolyte material layer may be about 10% to about 30%, about 10% to about 40%, about 10% to about 50%, about 10% to about 60%, about 10% to about 70%, about 10% to about 80%, about 10% to about 90%, about 20% to about 100%, about 30% to about 10%, about 40% to about 100%, about 50% to about 100%, about 60% to about 100%, about 70% to about 100%, or about 80% to about 100% by volume. In still further embodiments, the concentration of the solid-state electrolyte material of the present disclosure in the solid-state electrolyte material layer may be about 10%, 20%, 30%, 40%, 50%, 60%, 70%, 80%, 90%, or about 100% by volume.

In some embodiments, the solid-state electrolyte material layer may include a binder or other modifiers. In some aspects, the binder may include polyvinyl chloride, polyaniline, poly(methyl methacrylate), nitrile butadiene rubber, styrene-butadiene rubber, polystyrene, polyvinylidene fluoride, self-healing polymers, polyethylene oxide, or other binders known in the art and combinations thereof.

The solid-state electrolyte material layer may have a thickness of between about 1 μm to about 1000 μm. In some embodiments, the solid-state electrolyte material layer may have a thickness of about 1 μm to about 5 μm, about 5 μm to about 10 μm, about 10 μm to about 15 μm, about 15 μm to about 20 μm, about 20 μm to about 25 μm, about 25 μm to about 30 μm, about 30 μm to about 35 μm, about 35 μm to about 40 μm, about 40 μm to about 45 μm, about 45 μm to about 50 μm, about 50 μm to about 100 μm, about 100 μm to about 200 μm, about 200 μm to about 300 μm, about 300 μm to about 400 μm, about 400 μm to about 500 μm, about 500 μm to about 600 μm, about 600 μm to about 700 μm, about 700 μm to about 800 μm, about 800 μm to about 900 μm, or about 900 μm to about 1000 μm. In some additional embodiments, the solid-state electrolyte material layer may have a thickness of about 1 μm to about 10 μm, about 1 μm to about 15 μm, about 1 μm to about 20 μm, about 1 μm to about 25 μm, about 1 μm to about 30 μm, about 1 μm to about 35 μm, about 1 μm to about 40 μm, about 1 μm to about 45 μm, about 1 μm to about 50 μm, about 1 μm to about 100 μm, 1 μm to about 200 μm, about 1 μm to about 300 μm, about 1 μm to about 400 μm, about 1 μm to about 500 μm, about 1 μm to about 600 μm, about 1 μm to about 700 μm, about 1 μm to about 800 μm, about 1 μm to about 900 μm, about 5 μm to about 1000 μm, about 10 μm to about 1000 μm, about 15 μm to about 1000 μm, about 20 μm to about 1000 μm, about 25 μm to about 1000 μm, about 30 μm to about 1000 μm, about 35 μm to about 1000 μm, about 40 μm to about 1000 μm, about 45 μm to about 1000 μm, about 50 μm to about 1000 μm, about 100 μm to about 1000 μm, about 200 μm to about 1000 μm, about 300 μm to about 1000 μm, about 400 μm to about 1000 μm, about 500 μm to about 1000 μm, about 600 μm to about 1000 μm, about 700 μm to about 1000 μm, or about 800 μm to about 1000 μm. In still further embodiments, the solid-state electrolyte material layer may have a thickness of 1 μm, 5 μm, 10 μm, 15 μm, 20 μm, 25 μm, 30 μm, 35 μm, 40 μm, 45 μm, 50 μm, 100 μm, 200 μm, 300 μm, 400 μm, 500 μm, 600 μm, 700 μm, 800 μm, 900 μm, or about 1000 μm.

The electrochemical cell may comprise a positive electrode. The positive electrode may be formed from materials including aluminum, nickel, titanium, stainless steel, and carbon. In some embodiments positive electrode may include a positive electrode current collector and positive electrode composite. The positive electrode composite may include a positive electrode active material, binders, and conductive additives. In some aspects, positive electrode active material may include metal oxides, metal phosphates, metal sulfides, sulfur, lithium sulfide, oxygen, air, or other materials known in the art. The positive electrode active material may have a thickness of about 1 μm to about 1000 μm. The positive electrode active material may further include a solid-state electrolyte material of the present disclosure at a concentration of about 5% to about 80% by volume. In some additional aspects, the positive electrode binders may include polyvinyl chloride, polyaniline, poly(methyl methacrylate), nitrile butadiene rubber, styrene-butadiene rubber, polystyrene, polyvinylidene fluoride, or other binders known in the art and combinations thereof. In still additional aspects, the conductive additives may include carbon (e.g., carbon black, graphite, carbon nanotubes, carbon fiber, graphene, etc.), metal particles, filaments, or other structures, or other conductive additives known in the art and combinations thereof.

The electrochemical cell may comprise a negative electrode. The negative electrode may be formed from materials including copper, nickel, stainless steel, or carbon. The negative electrode may include a negative electrode active material, binders and conductive additives. In some embodiments, the negative electrode active material may include lithium metal, lithium alloys, silicon, tin (Sn), graphitic carbon, hard carbon, and may further include a solid electrolyte composition such as the solid electrolyte compositions described herein. The negative electrode active material may include a solid-state electrolyte material of the present disclosure at a concentration of about 5% to about 80% by volume. The negative electrode active material may have a thickness of about 1 μm to about 1000 μm. Examples of the binder used in the negative electrode may include those materials used in the positive electrode. Examples of the conductive additives used in the negative electrode may include those materials used in the positive electrode.

The discharge capacity of the electrochemical cell refers to the amount of electricity discharged from the battery during a discharge cycle. In some embodiments, an electrochemical cell comprising the solid-state electrolyte material of the present disclosure may have a higher discharge capacity as compared to an electrochemical cell comprising a solid-state electrolyte material with the general formula Li_{(7-w-z)}PS_{(6-w-z)}X_{w}Y_{z}, wherein X and Y are each a halogen or a pseudohalogen, wherein 0≤w≤2, 0≤z≤2, and w+z=2. In some additional embodiments, an electrochemical cell comprising the solid-state electrolyte material of the present disclosure has a higher discharge capacity as compared to an electrochemical cell comprising the same electrolyte material synthesized with 0 ppm H₂O and lacking an oxygen component. In still further embodiments, the discharge capacity of an electrochemical cell comprising the solid-state electrolyte material of the present disclosure may be about at least about 100 mAh/g. In some aspects, the discharge capacity may be at least about 110 mAh/g, at least about 120 mAh/g, or at least about 130 mAh/g. In some additional aspects, the discharge capacity may be about 100 mAh/g to about 105 mAh/g, about 105 mAh/g to about 110 mAh/g, about 110 mAh/g to about 115 mAh/g, about 115 mAh/g to about 120 mAh/g, about 120 mAh/g to about 125 mAh/g, about 125 mAh/g to about 130 mAh/g, or greater than about 130 mAh/g.

The first cycle efficiency of the electrochemical cell is defined as the ratio of the first discharge capacity to the first charge capacity. In some embodiments, an electrochemical cell comprising the solid-state electrolyte material of the present disclosure may have a higher first cycle efficiency as compared to an electrochemical cell comprising a solid-state electrolyte material with the general formula Li₆PS₅Cl. In some additional embodiments, an electrochemical cell comprising the solid-state electrolyte material of the present disclosure may have a higher first cycle efficiency as compared to an electrochemical cell comprising the same electrolyte material synthesized with 0 ppm H₂O and lacking an oxygen component. In still further embodiments, the first cycle efficiency may be greater than about 85%, greater than about 86%, greater than about 87%, greater than about 88%, greater than about 89%, greater than about 90%, greater than about 91%, greater than about 92%, greater than about 93%, greater than about 94%, greater than about 95%, greater than about 96%, greater than about 97%, greater than about 98%, or greater than about 99%. In some aspects, the first cycle efficiency may be about 85%, 86%, 87%, 88%, 89%, 90%, 91%, 92%, 93%, 94%, 95%, 96%, 97%, 98%, or about 99%. In an exemplary embodiment, an electrochemical cell comprising the solid-state electrolyte material of the present disclosure has a first cycle efficiency of greater than 88%.

In some embodiments, an electrochemical cell comprising the solid-state electrolyte material of the present disclosure may have a higher charge resistance as compared to an electrochemical cell having a solid-state electrolyte material with the general formula Li_{(7-w-z)}PS_{(6-w-z)}X_{w}Y_{z}, wherein X and Y are each a halogen or a pseudohalogen, wherein 0≤w≤2, 0≤z≤2, and w+z=2. In some additional embodiments, an electrochemical cell comprising the solid-state electrolyte material of the present disclosure may have a higher charge resistance as compared to the same electrolyte material synthesized with 0 ppm H₂O and lacking an oxygen component. In still further embodiments, the charge resistance of an electrochemical cell comprising the solid-state electrolyte material may be about 4 ohms to about 6 ohms. In some aspects, the charge resistance of an electrochemical cell comprising the solid-state electrolyte material may be about 4 ohms to about 4.5 ohms, about 4.5 ohms to about 5 ohms, about 5 ohms to about 5.5 ohms, or about 5.5 ohms to about 6 ohms. In some additional aspects, the charge resistance may be about 4 ohms, 4.25 ohms, 4.5 ohms, 4.75 ohms, 5 ohms, 5.25 ohms, 5.5 ohms, 5.75 ohms, or about 6 ohms.

### EXAMPLES

### Example 1: Characterization of the Electrolyte Material

A solid-state electrolyte material was prepared according to the process described herein. The electrolyte material included phosphorus and sulfur among the electrolyte precursors. The electrolyte material was synthesized with precursors having a water content of 0 ppm, 100 ppm, 250 ppm, 500 ppm, and 1000 ppm. Fourier Transform-Infrared Spectroscopy (FT-IR) was performed to characterize each of these samples (See FIG. 2). As seen in FIG. 2, as the water content of the electrolyte material increases, peaks at about 975 cm⁻¹, 690 cm⁻¹, and 525 cm⁻¹ increase in magnitude. Although the identity of the peaks is unknown, the peaks are characteristic of the materials described herein.

As shown in FIG. 2, as the water content of the electrolyte material increases, peaks corresponding to S—O and P—O bonds also increase in magnitude. As the increasing water content of the electrolyte material increases, the presence of oxygen in the material increases.

### Example 2: Performance of the Electrolyte Material

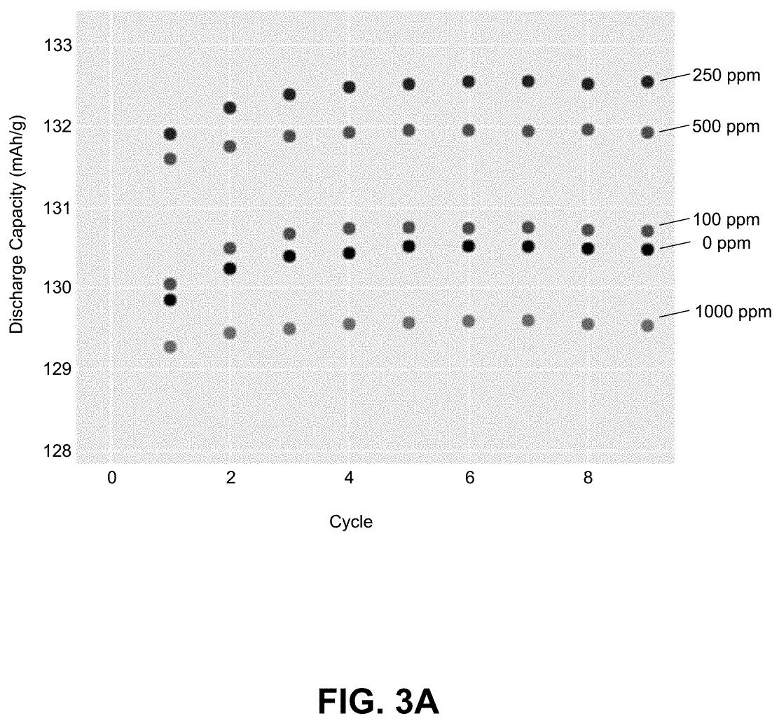

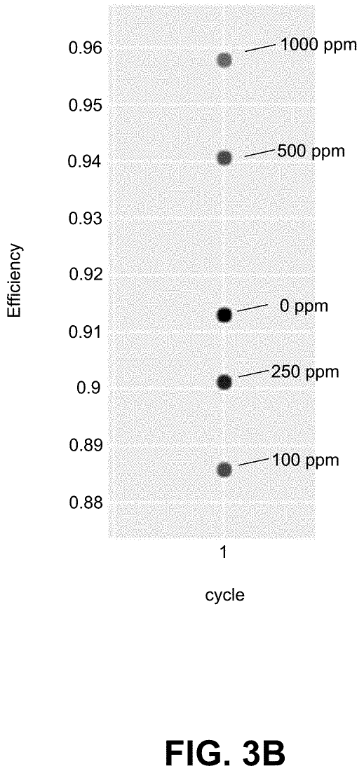

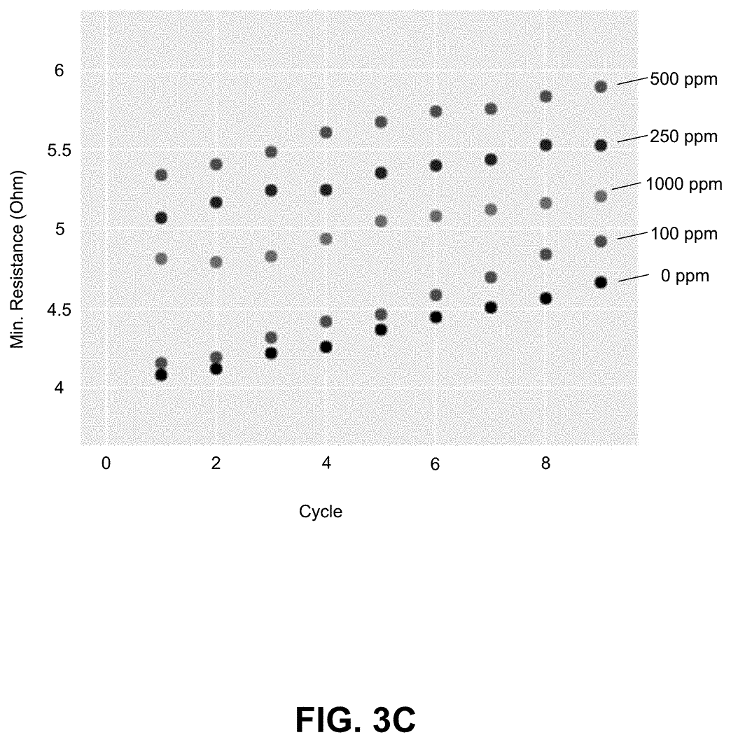

Performance testing was conducted on the electrolyte material of Example 1. The results of the performance tests are shown in FIGS. 3A-3C.

FIG. 3A shows the discharge capacity of the electrolyte material in mAh/g after charging cycles 1-12. The electrolyte materials having 100 ppm, 250 ppm, and 500 ppm water had a higher discharge capacity when compared to the same electrolyte material having 0 ppm or 1000 ppm water.

FIG. 3B shows the efficiency of the electrolyte material after charging cycles 1-5. The electrolyte materials having 500 ppm and 1000 ppm water had a higher first cycle efficiency (FCE) as compared to the electrolyte material having 0 ppm water. All electrolyte materials tested had a FCE of above at least 88%.

FIG. 3C shows the charge resistance of the electrolyte material after charging cycles 1-15. The electrolyte material having 1000 ppm water has a slightly lower increase in resistance as compared to the material having 0 ppm water.

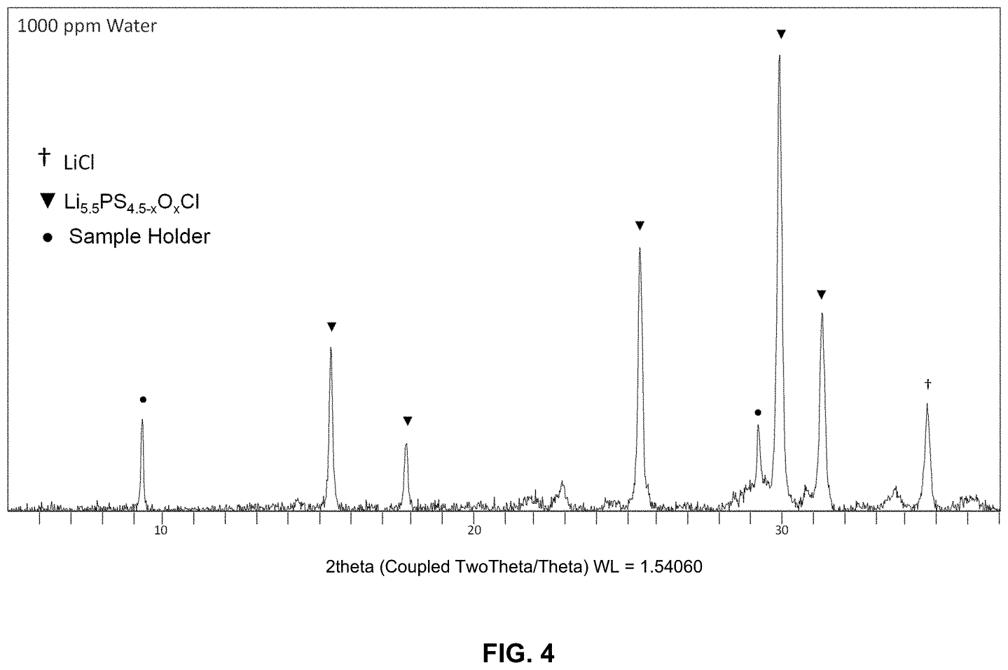

FIG. 4 shows an XRD pattern of the electrolyte material synthesized with precursors having 1000 ppm water. From the XRD patterns shown in FIG. 4, it can be observed that the electrolyte material is a composite containing the electrolyte phases of Li_{5.5}PS_{4.5-x}OₓCl, and LiCl. The Li_{5.5}PS_{4.5-x}OₓCl has peaks at 15.4°, 17.9°, 25.4°, 29.9°, and 31.4°. The LiCl has a peak at 34.7°.

### Example 3: Electrolyte Material Having 100,000 ppm Water

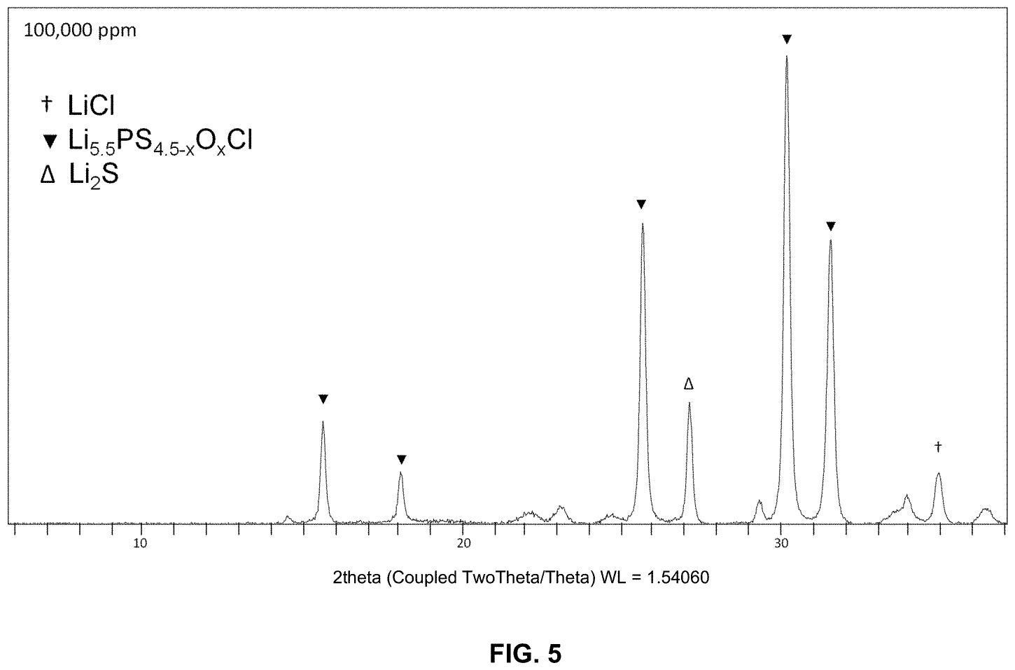

An electrolyte material synthesized with precursors and a solvent having 100,000 ppm water was made according to the methods of the present disclosure. From the XRD patterns shown in FIG. 5, it can be observed that the electrolyte material is a composite containing the electrolyte phases of Li₅₅PS_{4.5-x}OₓCl, Li₂S, and LiCl. The Li₅₅PS_{4.5-x}OₓCl has peaks at 15.7°, 18.1°, 25.6°, 29.8°, and 31.6°. The Li₂S has a peak at 27.2°. The LiCl has a peak at 34.9°.

What is claimed is:

1. An electrochemical cell comprising
a positive electrode; and
an electrolyte material disposed between the positive electrode and a negative electrode, wherein,
the electrolyte material has the general structure Li_{7-w-z}PS_{6-w-z-v}OᵥX_{w}Y_{z}; wherein
X and Y are each one or more of a halogen and a pseudohalogen;
0≤w≤2;
0≤z≤2; and
0<v≤1.

2. The electrochemical cell of claim 1, wherein X and Y are each selected from the group consisting of F, Cl, Br, I, BF₄, BH₄, NO₂, and NO₃.

3. The electrochemical cell of claim 1, wherein the electrolyte material has a FT-IR spectrum with absorption peaks at 975±25 cm⁻¹, 690±25 cm⁻¹, and 525±25 cm⁻¹.

4. The electrochemical cell of claim 1, wherein the electrochemical cell has a higher discharge capacity as compared to an electrochemical cell comprising an electrolyte material having the general formula Li_{7-w-z}PS_{6-w-z}X_{w}Y_{z}.

5. The electrochemical cell of claim 1, wherein the electrochemical cell has a higher first cycle efficiency as compared to an electrochemical cell comprising an electrolyte material having the general formula Li_{7-w-z}PS_{6-w-z}X_{w}Y_{z}.

6. The electrochemical cell of claim 1, wherein the electrochemical cell has first cycle efficiency of at least about 88%.

7. The electrochemical cell of claim 1, wherein the electrochemical cell has a lower charge resistance as compared to an electrochemical cell comprising an electrolyte material having the general formula Li_{7-w-z}PS_{6-w-z}X_{w}Y_{z}.

8. A process for manufacturing an electrolyte material, the process comprising milling a mixture including:
a plurality of electrolyte precursors, the electrolyte precursors comprising
one or more Lithium (Li) containing materials;
one or more Phosphorus (P) containing materials;
a halide or a pseudohalide;
one or more solvents; and
water.

9. The process of claim 8, wherein the electrolyte precursors further comprise sulfur (S) containing materials.

10. The process of claim 8, wherein the electrolyte precursors further comprise one or more of a halide containing material or a pseudohalide containing material.

11. The process of claim 8, further comprising heating the mixture after the milling.

12. The process of claim 11, wherein the heating results in crystallization of the mixture to form the electrolyte material.

13. The process of claim 8, wherein the mixture includes at least 100 ppm water.

14. The process of claim 13, wherein the mixture includes about 250 ppm water.

15. The process of claim 13, wherein the mixture includes about 500 ppm water.

16. The process of claim 13, wherein the mixture includes about 1000 ppm water.

17. The process of claim 13, wherein the mixture includes about 100,000 ppm water.

18. The process of claim 8, wherein the water is added to the solvent prior to the milling.

19. The process of claim 8, wherein at least one of the plurality of electrolyte precursors is anhydrous.

20. The process of claim 8, wherein the amount of water added is predetermined based on the amount of water contained in the plurality of the electrolyte precursors and the amount of water contained in the solvent.

21. The process of claim 8, wherein the solvent is a low-polarity, aprotic solvent.

22. The process of claim 21, wherein the solvent is selected from the group consisting of xylenes, toluene, benzene, heptane, and combinations thereof.

23. The process of claim 8, wherein the solvent comprises an ether, an ester, a nitrile, or an alcohol.

24. An electrochemical cell comprising
a positive electrode;
an electrolyte material; and
a negative electrode;
wherein,
the electrolyte material is disposed between the positive electrode and the negative electrode, and
the electrolyte material is made by the process of claim 8.

25. A solid-state electrolyte material comprising:
Li, T, X, A, O, and, optionally, Y, wherein,
T is at least one element selected from the group consisting of P, As, Si, Ge, Al, and B;
X and, when present, Y is a halogen or a pseudohalogen;
A is at least one element selected from the group consisting of S, Se, and N; and
the electrolyte material has FT-IR peaks at about 975 cm⁻¹±25 cm⁻¹, 690 cm⁻¹±25 cm⁻¹, and 525 cm⁻¹±25 cm⁻¹.

26. The solid-state electrolyte material of claim 25, wherein T is P.

27. The solid-state electrolyte material of claim 25, wherein X is Cl.

28. The solid-state electrolyte material of claim 25, wherein A is S.

29. The solid-state electrolyte material of claim 25, wherein the material is represented by the formula Li_{7-w-z}PS_{6-w-z-v}OᵥX_{w}Y_{z}.

30. The solid-state electrolyte material of claim 29, wherein 0<v≤1.

31. The solid-state electrolyte material of claim 29, wherein the solid electrolyte material has an FT-IR as depicted in FIG. 2.

32. The solid-state electrolyte material of claim 29, wherein the amount of oxygen present is based on exposure to 40 ppm to 1000 ppm water.

33. The solid-state electrolyte material of claim 29, wherein an electrochemical cell comprising the electrolyte material has a higher discharge capacity as compared to an electrochemical cell comprising the same electrolyte material synthesized with 0 ppm H₂O and lacking an oxygen component.

34. The solid-state electrolyte material of claim 29, wherein an electrochemical cell comprising the electrolyte material has a higher First Cycle Efficiency (FCE) as compared to an electrochemical cell comprising the same electrolyte material exposed to 0 ppm H₂O and lacking an oxygen component.

35. The solid-state electrolyte material of claim 29, wherein an electrochemical cell comprising the electrolyte material has a lower resistance rise as compared to an electrochemical cell comprising the same electrolyte material exposed to 0 ppm H₂O and lacking an oxygen component.

36. The solid-state electrolyte material of claim 25, wherein the electrolyte material has an ionic conductivity of at least 1×10⁻⁴ mS/cm².

37. A method of preparing a solid-state electrolyte material comprising
mixing reactants in accordance with the reaction below to yield a solid-state electrolyte material of the formula Li₆PS_{5-E}O_{E}Cl:
XLi₂S_{(A ppm H2O)}+YP₂S_{5(B ppm H2O)}+ZLi_{X(C ppm H2O)}+WSolvent_{(D ppm H2O)}→Li6P_{S5-E}O_{E}Cl+WSolvent;
wherein E=(X*A)+(Y*B)+(Z*C)+(W*D)
A, B, C, and D=ppm of H₂O per unit mass, and
Z, Y, Z, and W=Unit mass; and,
controlling the ppm of water for each precursor and solvent to create an electrolyte material that has high ionic conductivity while having low reactivity against a high nickel content cathode.
